(19) United States
(12) Patent Application Publication
(10) Pub. No.: US 2026/0320181 A1
(43) Pub. Date: Oct. 15, 2026

(54) SECURITY PROTECTION SYSTEM AND SECURITY PROTECTION METHOD

(71) Applicant: ASUSTEK COMPUTER INC., TAIPEI (TW)

(72) Inventors: Hung-Chang CHANG, TAIPEI (TW); Ching-Wei LIN, TAIPEI (TW); Po-Yu KO, TAIPEI (TW); Ching-Po CHIN, TAIPEI (TW)

(21) Appl. No.: 19/321,839

(22) Filed: Sep. 8, 2025

(30) Foreign Application Priority Data
Apr. 11, 2025 (TW) 114113795

(51) Int. Cl. G06F 21/55; G06F 18/2411; G06F 21/56

(52) U.S. Cl. CPC G06F 21/554; G06F 18/2411; G06F 21/566

(57) ABSTRACT

The disclosure provides a security protection method, performed by a computer device. The security protection method includes the following steps. In a training stage, user operation data of the computer device is first obtained. Subsequently, a behavior model is trained through the user operation data. In a prediction stage, it is determined, through the trained behavior model, whether a current operation behavior of the computer device is an abnormal behavior or not. When it is determined that the current operation behavior is the abnormal behavior, an abnormal behavior notification message is generated. The disclosure also provides a security protection system.

### CROSS-REFERENCE TO RELATED APPLICATION

This application claims the priority benefit of Taiwan Application Serial No. 114113795, filed on Apr. 11, 2025. The entirety of the above-mentioned patent application is hereby incorporated by reference herein and made a part of specification.

### BACKGROUND OF THE INVENTION

### Field of the Invention

The disclosure relates to the technical field of security protection, and in particular, to a security protection system applicable to a computer device and a security protection method.

### Description of the Related Art

An existing computer security protection system (especially a standalone protection system) lacks sufficient real-time detection and response capabilities in the face of increasingly complex network threats, making it difficult to effectively protect user privacy data and system security.

In an embodiment, the existing computer security protection system does not effectively identify a malicious user, prevent malware from monitoring a screen and a keyboard input, or prevent unauthorized data access.

### BRIEF SUMMARY OF THE INVENTION

The disclosure provides a security protection method, performed by a computer device. The security protection method includes the following steps. In a training stage, user operation data of the computer device is first obtained. Subsequently, a behavior model is trained through the user operation data. In a prediction stage, it is determined, through the trained behavior model, whether a current operation behavior of the computer device is an abnormal behavior or not. When it is determined that the current operation behavior is the abnormal behavior, an abnormal behavior notification message is generated.

The disclosure also provides a security protection system, applicable to a computer device. The security protection system includes a behavior model, a training unit, a behavior determination unit, and a warning unit. The training unit is electrically coupled to the behavior model, and is adapted to obtain user operation data of the computer device, and train the behavior model through the user operation data. The behavior determination unit is electrically coupled to the behavior model, and is adapted to determine, through the trained behavior model, whether a current operation behavior of the computer device is an abnormal behavior or not. The warning unit is electrically coupled to the behavior determination unit. When it is determined that the current operation behavior is the abnormal behavior, the behavior determination unit instructs the warning unit to generate an abnormal behavior notification message.

An existing computer security protection system (especially a standalone protection system) lacks sufficient real-time detection and response capabilities in the face of increasingly complex network threats, making it difficult to effectively protect user privacy data and system security. In contrast, through the security protection method and security protection system provided in the disclosure, user operation data of the computer device is obtained to train the behavior model, and it is determined, through the trained behavior model, whether the current operation behavior of the computer device is an abnormal behavior or not. In this way, a malicious user and an unauthorized operation behavior are identified based on a change in an operation mode of the computer device, to prevent malware from monitoring a screen and a keyboard input or unauthorized data access.

### BRIEF DESCRIPTION OF THE DRAWINGS

FIG. 1 is a schematic block diagram of a security protection system during execution in a training stage according to an embodiment of the disclosure;

FIG. 2 is a schematic block diagram of a security protection system during execution in a prediction stage according to an embodiment of the disclosure;

FIG. 3 is a schematic block diagram of a security protection system according to another embodiment of the disclosure;

FIG. 4 is a flowchart of a security protection method according to an embodiment of the disclosure; and

FIG. 5 is a flowchart of a security protection method according to another embodiment of the disclosure.

### DETAILED DESCRIPTION OF THE EMBODIMENTS

Specific embodiments of the disclosure are described in more details below with reference to the schematic diagrams. Advantages and features of the disclosure are to be clearer according to the following descriptions and claims. It is to be noted that all figures are in a very simple form and in an inaccurate proportion, and are merely intended to assist in convenient and clear description of the embodiments of the disclosure.

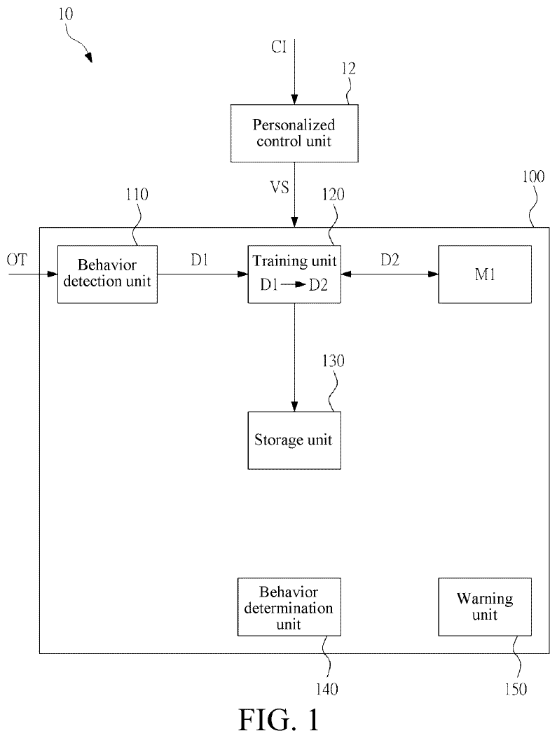

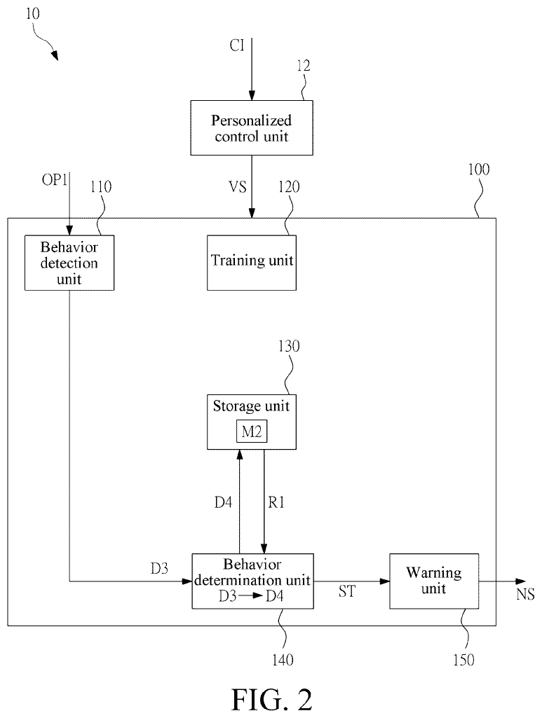

FIG. 1 is a schematic block diagram of a security protection system 100 during execution in a training stage according to an embodiment of the disclosure. FIG. 2 is a schematic block diagram of a security protection system 100 during execution in a prediction stage according to an embodiment of the disclosure.

The security protection system 100 is adapted to be installed in a computer device 10, to provide security protection for the computer device 10. The computer device 10 is a terminal device such as a desktop computer, a notebook computer, a tablet computer, or a smartphone. However, the disclosure is not limited thereto. In another embodiment, the computer device 10 is also a server.

As shown in the figure, the security protection system 100 includes a behavior model M1, a behavior detection unit 110, a training unit 120, a storage unit 130, a behavior determination unit 140, and a warning unit 150.

Refer to FIG. 1 additionally. In the training stage, the behavior detection unit 110 is adapted to detect a training operation behavior OT of the computer device 10 to obtain user operation data D1 corresponding to the training operation behavior OT.

The training unit 120 is electrically coupled to the behavior detection unit 110 and the behavior model M1, and is adapted to process the user operation data D1 to generate training data D2, and train the behavior model M1 through the training data D2. The behavior model M1 trained by the training unit 120 is stored in the storage unit 130 for use in the subsequent prediction stage.

The behavior model M1 is a binary classification model, such as a support vector machine (SVM) model. An SVM is a supervised machine learning algorithm that classifies data by finding the optimal line or hyperplane that maximizes a distance between each category in an N-dimensional space. In the disclosure, the behavior model M1 needs to be trained to determine whether the operation behavior of the computer device 10 is an abnormal behavior (which is classified into an abnormal behavior and a non-abnormal behavior) or not.

The user operation data D1 includes system resource usage data and privacy setting data. The system resource usage data refers to data related to system operation status such as a usage rate of a central processing unit (CPU), memory usage, hard disk access times and frequency, and network usage bandwidth and traffic of the computer device. In an embodiment, the system resource usage data includes a CPU load percentage, a memory (such as a random access memory (RAM)) usage status, disk read and write times, a network connection record, and the like. The privacy setting data refers to a system setting value and an authorization status related to user personal privacy. In an embodiment, the privacy setting data includes microphone and camera start status, application access permission settings, location information sharing settings, and the like. In an embodiment, the computer device 10 is provided with a personalized control unit 12. The personalized control unit 12 allows a user to set a system resource usage status and a privacy status of the computer device 10. The personalized control unit 12 controls a system setting value VS of the computer device 10 in response to a control instruction CI inputted by the user. The behavior detection unit 110 obtains the system setting value VS as the user operation data D1 and provide the user operation data to the training unit 120 for training the behavior model M1.

The training unit 120 provided in this embodiment is configured to regard the behavior model M1 as completed after training with a default amount of user operation data D1 and store the trained behavior model in the storage unit 130. For ease of description, the trained behavior model is marked as M2 in the figure. In an embodiment, the preset amount is 20,000 pieces of user operation data D1. However, the disclosure is not limited thereto. In another embodiment, the behavior model M2 that has been preliminarily trained is trained through operation data (such as current operation data D3) obtained in the prediction stage.

Refer to FIG. 2 additionally. In the prediction stage, the behavior detection unit 110 is adapted to detect a current operation behavior OP1 of the computer device 10 to obtain current operation data D3 corresponding to the current operation behavior OP1. In an embodiment, the current operation data D3 is abnormal usage of system resources detected in real time., such as an abnormally high CPU or memory load, an abnormal network connection status, or a change record of detected unauthorized access to user privacy settings.

In an embodiment, the personalized control unit 12 controls the system setting value VS of the computer device 10 in response to the control instruction CI inputted by the user. The behavior detection unit 110 obtains the system setting value VS as current operation data D3 and provides the current operation data to the behavior determination unit 140 to determine whether the current operation behavior is an abnormal behavior or not.

The behavior determination unit 140 is electrically coupled to the behavior detection unit 110 and the storage unit 130, and is adapted to obtain the current operation data D3 and process the current operation data D3 to generate data D4 for prediction. The foregoing conversion manner of converting the current operation data D3 into the data D4 for prediction is similar to the foregoing conversion manner of converting the user operation data D1 into the training data D2 in the training stage.

The behavior determination unit 140 inputs the data D4 for prediction into the trained behavior model M2 to obtain a classification result R1. The classification result R1 is used to determine whether the current operation behavior OP1 is an abnormal behavior or not. When determining that the current operation behavior OP1 is an abnormal behavior, the behavior determination unit 140 generates a trigger message ST to trigger the warning unit 150 to operate.

The warning unit 150 is electrically coupled to the behavior determination unit 140, and is adapted to receive the trigger message ST to generate an abnormal behavior notification message NS. In an embodiment, the abnormal behavior notification message NS is a warning screen, a warning lamp signal, or a warning sound effect.

In an embodiment, the user further determines, based on the abnormal behavior notification message NS, whether the determination result of the behavior model M1 is correct or not, to provide feedback to the behavior model M1. The training unit 120 obtains the data to continuously train (fine-tune) the behavior model M1.

In the embodiments of FIG. 1 and FIG. 2 mentioned above, the security protection system 100 notifies the user of occurrence of the abnormal behavior through the abnormal behavior notification signal generated by the warning unit 150. However, the disclosure is not limited thereto.

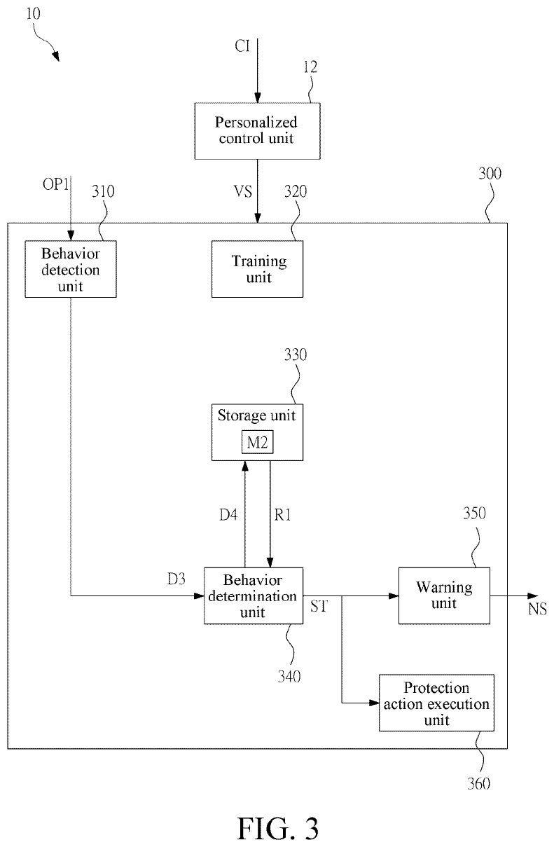

In an actual usage status, sometimes the user is not beside the computer device 10, or is delayed by other things and does not respond to the abnormal behavior notification signal generated by the warning unit 150 in time. FIG. 3 is a schematic block diagram of a security protection system 300 according to another embodiment of the disclosure.

As shown in the figure, the security protection system 300 includes a behavior model M1, a behavior detection unit 310, a training unit 320, a storage unit 330, a behavior determination unit 340, a warning unit 350, and a protection action execution unit 360.

The protection action execution unit 360 is electrically coupled to the behavior determination unit 340. When the behavior determination unit 340 determines that a current operation behavior OP1 is an abnormal behavior, the behavior determination unit 340 immediately instructs the protection action execution unit 360 to control the computer device 10 to shut down, log off a user, or cut off network connection of the computer device 10 through a control panel of the computer device 10, to prevent the abnormal behavior from causing harm to the computer device 10. The above three types of security protection actions are only illustrative, and based on actual requirements, the protection operations to be performed by the protection action execution unit 360 are not limited thereto.

Other components of the security protection system 300 in this embodiment, such as the behavior model M1, the behavior detection unit 310, the training unit 320, the storage unit 330, the behavior determination unit 340, and the warning unit 350, are similar to those in the embodiments of FIG. 1 and FIG. 2, and details are not described herein.

In addition, it is to be noted that before the behavior model M1 provided in the previous embodiment completes training (that is, in the training stage), the computer device 10 performs protection through other security protection mechanisms owned by itself, such as a data backup and protection mechanism (such as data compression, backup storage, and restoration tools), a resource monitoring module (such as CPU monitoring, memory monitoring, and network monitoring), a privacy protection module (such as folder encryption, application locking, and screen keyboard monitoring), and a core protection module (such as malware scanning, intrusion detection, and secure deletion functions).

After the behavior model M1 provided in the previous embodiment completes the training, an additional security protection function for abnormal behavior monitoring is provided in addition to the security protection mechanism of the computer device 10, to enhance privacy protection for users and effectively compensate for shortcomings of a conventional security protection mechanism.

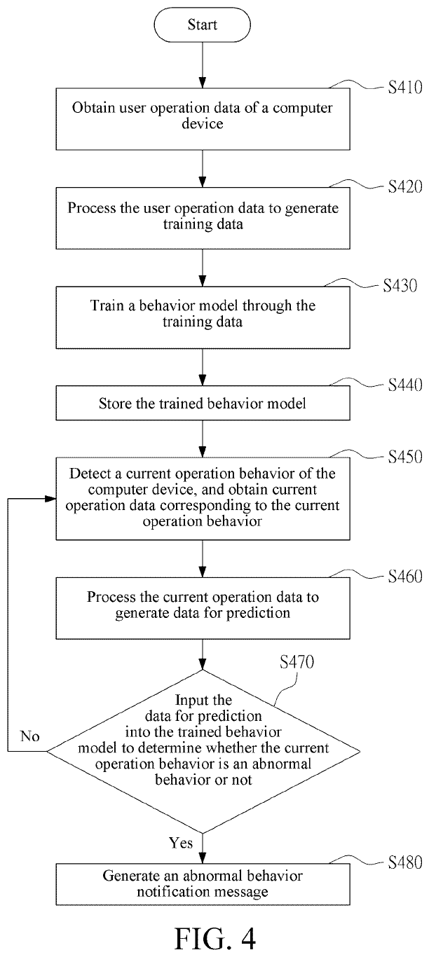

FIG. 4 is a flowchart of a security protection method according to an embodiment of the disclosure. The security protection method is performed by the security protection system 100 shown in FIG. 1 and FIG. 2. The security protection system 100 is installed in a computer device 10. The computer device 10 is a terminal device such as a desktop computer, a notebook computer, a tablet computer, or a smartphone. However, the disclosure is not limited thereto. In another embodiment, the computer device 10 is also a server.

As shown in the figure, the security protection method of this embodiment is divided into a training stage and a prediction stage.

In the training stage, firstly, as described in step S410, user operation data D1 of the computer device 10 is obtained. Subsequently, as described in step S420, the user operation data D1 is processed to generate training data D2. Specifically, step S420 is to convert the user operation data D1 obtained by the computer device 10 into training data D2 adapted to train the behavior model M1.

Then, as described in step S430, a behavior model M1 is trained through the training data D2. After it is determined that the behavior model M1 has completed training, as described in step S440, the trained behavior model M2 is stored.

The foregoing user operation data D1 includes system resource usage data and privacy setting data. The system resource usage data refers to various hardware resource usage and monitoring data generated by the computer device during operation. In an embodiment, the system resource usage data includes processor load information, memory usage, a read/write frequency of a storage device, network traffic, and connection status information. The privacy setting data refers to relevant setting information generated by control and setting of personal privacy by a user. In an embodiment, the privacy setting data includes system permission setting data, personal information sharing setting status, and an on or off state of an interface device (such as a microphone and a camera). The foregoing steps S420 to S440 are performed by the training unit 120 in FIG. 1.

In the prediction stage, firstly, as described in step S450, a current operation behavior OP1 of the computer device 10 is detected, and current operation data D3 corresponding to the current operation behavior OP1 is obtained. Subsequently, as described in step S460, the current operation data D3 is processed to generate data D4 for prediction. Specifically, step S460 is to convert the current operation data D3 obtained by the computer device 10 into the data D4 for prediction adapted to be inputted into the behavior model M2 for prediction.

Next, as described in step S470, it is determined, through the trained behavior model M2, whether the current operation behavior OP1 is an abnormal behavior or not. In an embodiment, step S470 is to input the data D4 for prediction into the trained behavior model M2, and determine, based on an output of the behavior model M2, whether the current operation behavior OP1 is an abnormal behavior or not. The step is performed by the behavior determination unit 140 in FIG. 1 in combination with the trained behavior model M2.

When it is determined that the current operation behavior OP1 is an abnormal behavior, the process proceeds to step S480 of generating an abnormal behavior notification message NS. This step is performed by the warning unit 150 in FIG. 1. On the contrary, when it is determined that the current operation behavior OP1 is not an abnormal behavior, the process returns to step S450 of still monitoring the computer device 10.

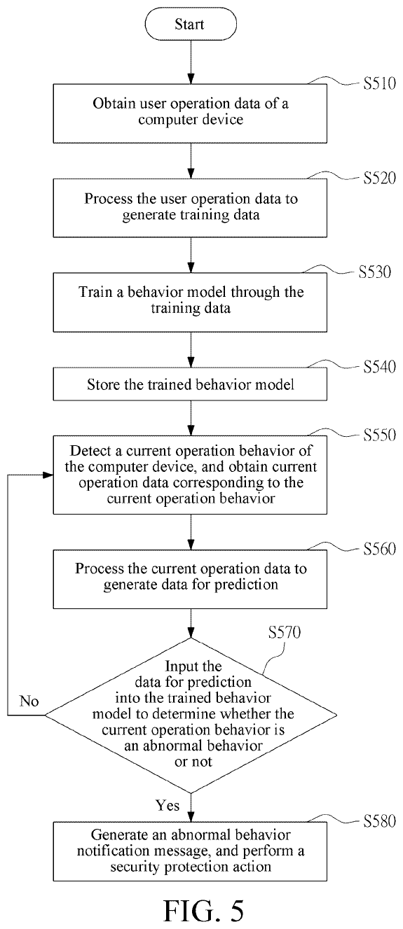

FIG. 5 is a flowchart of a security protection method according to another embodiment of the disclosure. The security protection method is performed by the security protection system 100 shown in FIG. 3. The security protection system 100 is installed in a computer device 10.

As shown in the figure, the security protection method of this embodiment is divided into a training stage and a prediction stage.

In the training stage, firstly, as described in step S510, user operation data D1 of the computer device 10 is obtained. Subsequently, as described in step S520, the user operation data D1 is processed to generate training data D2.

Then, as described in step S530, a behavior model M1 is trained through the training data D2. After it is determined that the behavior model M1 has completed training, as described in step S540, the trained behavior model M2 is stored. The foregoing steps S520 to S540 are performed by the training unit 120 in FIG. 3.

In the prediction stage, firstly, as described in step S550, a current operation behavior OP1 of the computer device 10 is detected, and current operation data D3 corresponding to the current operation behavior OP1 is obtained. Subsequently, as described in step S560, the current operation data D3 is processed to generate data D4 for prediction.

Next, as described in step S570, the data D4 for prediction is inputted into the trained behavior model M2 to determine whether the current operation behavior OP1 is an abnormal behavior or not. The step is performed by the behavior determination unit 140 in FIG. 3 in combination with the trained behavior model M2.

When it is determined that the current operation behavior OP1 is an abnormal behavior, as shown in step S580, an abnormal behavior notification message NS is generated, and a security protection action is performed. The step is performed by the warning unit 150 and the protection action execution unit 360 in FIG. 3. In an embodiment, the security protection action is to control the computer device 10 to shut down, log out the user, or cut off the network connection of the computer device 10. However, the disclosure is not limited thereto.

On the contrary, when it is determined that the current operation behavior OP1 is not an abnormal behavior, the process returns to step S550 of still monitoring the computer device 10.

The existing computer security protection system 100 (especially a standalone protection system) lacks sufficient real-time detection and response capabilities in the face of increasingly complex network threats, making it difficult to effectively protect user privacy data and system security. In contrast, through the security protection method and security protection system 100 provided in the disclosure, user operation data D1 of the computer device 10 is obtained to train the behavior model M1, and it is determined, through the trained behavior model M2, whether the current operation behavior OP1 of the computer device 10 is an abnormal behavior or not. In this way, a malicious user and an unauthorized operation behavior are identified based on a change in an operation mode of the computer device 10, to prevent malware from monitoring a screen and a keyboard input or unauthorized data access.

The foregoing descriptions are merely preferred embodiments of the disclosure, and do not impose any limitation on the disclosure. Any form of change such as an equivalent replacement or modification made by any person skilled in the art to technical means and technical content disclosed in the disclosure without departing from scope of the technical means of the disclosure is content that does not deviate from the technical means of the disclosure, and still falls within protection scope of the disclosure.

What is claimed is:

1. A security protection method, performed by a computer device, the method comprising:
obtaining user operation data of the computer device;
processing the user operation data to generate training data;
training a behavior model through the training data;
storing the trained behavior model;
detecting a current operation behavior of the computer device to obtain current operation data corresponding to the current operation behavior;
processing the current operation data to generate data for prediction;
inputting the data for prediction into the trained behavior model to determine whether the current operation behavior is an abnormal behavior or not; and
generating an abnormal behavior notification message when it is determined that the current operation behavior is the abnormal behavior.

2. The security protection method according to claim 1, wherein the user operation data comprises system resource usage data and privacy setting data.

3. The security protection method according to claim 1, wherein when it is determined that the current operation behavior is the abnormal behavior, the method further comprises controlling the computer device to shut down.

4. The security protection method according to claim 1, wherein when it is determined that the current operation behavior is the abnormal behavior, the method further comprises logging out a user from the computer device.

5. The security protection method according to claim 1, wherein when it is determined that the current operation behavior is the abnormal behavior, the method further comprises cutting off network connection of the computer device.

6. The security protection method according to claim 1, wherein the computer device is a terminal device.

7. The security protection method according to claim 1, wherein the behavior model is a support vector machine (SVM) model.

8. The security protection method according to claim 1, wherein the computer device has a personalized control unit adapted to control a system setting value of the computer device in response to a control instruction inputted by a user, wherein the step of obtaining the user operation data of the computer device is obtaining the system setting value as the user operation data.

9. A security protection system, applicable to a computer device, the security protection system comprising:
a behavior model;
a behavior detection unit, adapted to detect a training operation behavior of the computer device in a training stage to obtain user operation data corresponding to the training operation behavior, and adapted to detect a current operation behavior of the computer device in a prediction stage to obtain current operation data corresponding to the current operation behavior;
a training unit, electrically coupled to the behavior detection unit and the behavior model, and adapted to process the user operation data to generate training data, and train the behavior model through the training data;
a storage unit, adapted to store the trained behavior model;
a behavior determination unit, electrically coupled to the behavior detection unit and the storage unit, and adapted to process the current operation data to generate data for prediction, input the data for prediction into the trained behavior model to determine whether the current operation behavior is an abnormal behavior or not, and generate a trigger message when determining that the current operation behavior is the abnormal behavior; and
a warning unit, electrically coupled to the behavior determination unit, and adapted to receive the trigger message to generate an abnormal behavior notification message.

10. The security protection system according to claim 9, wherein the user operation data comprises system resource usage data and privacy setting data.

11. The security protection system according to claim 9, further comprising a protection action execution unit, wherein the protection action execution unit is electrically coupled to the behavior determination unit, and is adapted to receive the trigger message to control the computer device to shut down.

12. The security protection system according to claim 9, wherein the computer device is a terminal device.

13. The security protection system according to claim 9, wherein the behavior model is a SVM model.

14. The security protection system according to claim 9, wherein the computer device has a personalized control unit adapted to control a system setting value of the computer device in response to a control instruction inputted by a user, wherein the training unit is electrically coupled to the personalized control unit, and is adapted to obtain the system setting value as the user operation data.
